(19) United States
(12) Patent Application Publication
(10) Pub. No.: US 2022/0001565 A1
(43) Pub. Date: Jan. 6, 2022

(54) BONUS BEAUTY EXTRACTION DEVICE

(71) Applicants: Elida Ruiz, Seattle, WA (US); Blake Waggoner, Seattle, WA (US)

(72) Inventors: Elida Ruiz, Seattle, WA (US); Blake Waggoner, Seattle, WA (US)

(21) Appl. No.: 16/920,377

(22) Filed: Jul. 2, 2020

(51) Int. Cl. B26D 7/22; A45D 40/00; A45D 34/00

(52) U.S. Cl. CPC B26D 7/22; A45D 40/00; A45D 2034/002; A45D 2040/0006; A45D 34/00

(57) ABSTRACT

An article of manufacture for an all-in-one beauty product extraction device is disclosed. The extraction device comprises a device frame, a soft tube capture slot, a locking and sealing arm, and a cutting handle. A safely-contained cutting blade is coupled to an underside of the cutting handle. The cutting handle wraps around the locking and sealing arm such that the cutting handle may slide up and down the length of the locking and sealing arm to cut the soft tube. Leaving the locking and sealing arm in a closed position seals the soft tube by pinching the opened end shut between an edge of the soft tube capture slot and the locking and sealing arm.

### TECHNICAL FIELD

This application relates in general to an article of manufacture for providing a beauty product device, and more specifically, to an article of manufacture for an all-in-one beauty product extraction device.

### BACKGROUND

The traditional practice with the capped soft tubes of expensive beauty products is to discard the soft tube once the product cannot be easily accessed by squeezing the tube. Most people do not understand how much product is left inside the soft tube: usually several more applications. Users would benefit from a device that provides an ability to cut open the soft tub of beauty product, access the product inside the tube, and then seal the tube in an all-in-one device for later use. An all-in-one device does not exist to aid consumers in preventing the waste of expensive products contained within the soft tubes.

Therefore, a need exists for an article of manufacture for providing a beauty product extraction device. Currently prior art does not exist that combines the opening and accessing of difficult-to-access product inside a soft tube with the ability to seal the container to extend the life of the product in a single, all-in-one device. A lot of expensive beauty product is typically wasted because of the lack of an all-in-one device to aid in the extraction of the beauty product. The present invention attempts to address these deficiencies found in prior art solutions.

### SUMMARY

In accordance with the present invention, the above and other problems are solved by providing an article of manufacture an all-in-one beauty product extraction device according to the principles and example embodiments disclosed herein.

In one embodiment, the present invention is an article of manufacture for an all-in-one beauty product extraction device. The extraction device comprises a device frame, a soft tube capture slot, a locking and sealing arm, and a cutting handle. A safely-contained cutting blade is coupled to an underside of the cutting handle. The cutting handle wraps around the locking and sealing arm such that the cutting handle may slide up and down the length of the locking and sealing arm to cut the soft tube. Leaving the locking and sealing arm in a closed position seals the soft tube closed by pinching the opened end shut between an edge of the soft tube capture slot and the locking and sealing arm.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment for an article of manufacture for an all-in-one beauty product extraction device according to the present invention.

FIG. 2 illustrates another example embodiment of an article of manufacture for an all-in-one beauty product extraction device according to the present invention.

FIG. 3 illustrates a third example embodiment of an article of manufacture for an all-in-one beauty product extraction device according to the present invention.

### DETAILED DESCRIPTION

This application relates in general to a beauty product device, and more specifically, to an article of manufacture for an all-in-one beauty product extraction device according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The terms “customer,” and “user” refer to an entity, e.g. a human, using a beauty product that may be extracted for use by a device associated with the invention. The term user herein refers to one or more users.

The term “invention” or “present invention” refers to the invention being applied for via the patent application with the title “Bonus Beauty Extraction Device.” Invention may be used interchangeably with beauty product extraction device.

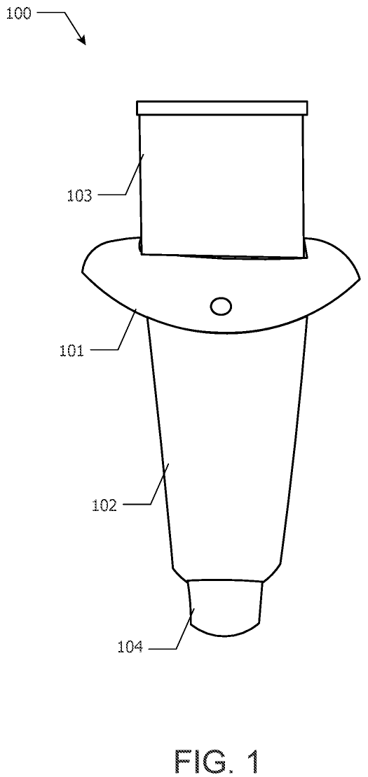

In general, the present disclosure relates to an article of manufacture for an all-in-one beauty product extraction device. To better understand the present invention, FIG. 1 illustrates an example embodiment for an article of manufacture for providing a beauty product extraction device according to the present invention.

This article of manufacture 100 is an all-in-one tool used to access and utilize all of the product located in a capped soft tube cosmetic container 102 that would normally be discarded as waste because it was unable to be accessed by squeezing the tube. This device 101 will squeeze the product to one end of the tube 102 while leaving a second end of the soft tube 103 empty of the beauty product. Using such an extraction device 101 may help the user gain access to all of the beauty product contained within the soft tube 102 in a small all-in-one device that may be carried by the user in a purse or a similar bag that's carried on a daily basis.

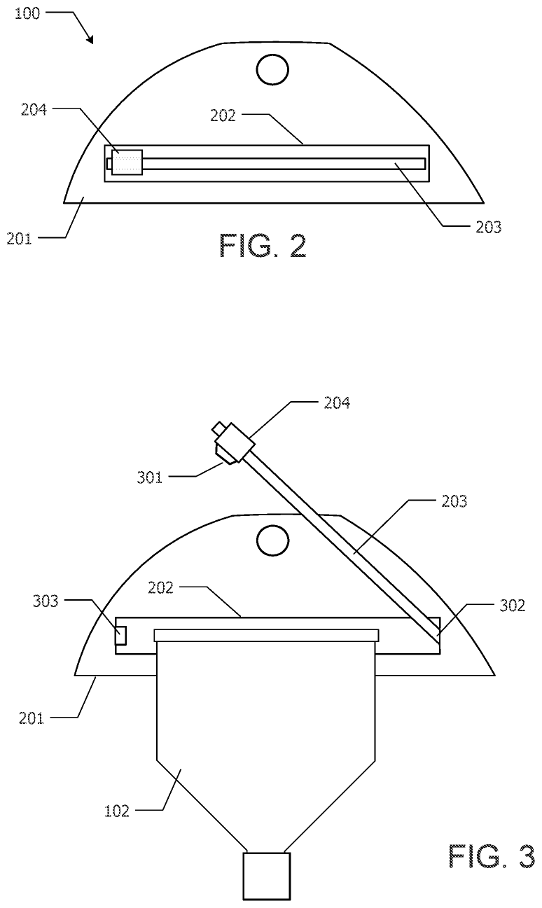

FIG. 2 illustrates another example embodiment of an article of manufacture for providing an all-in-one beauty product extraction device according to the present invention. The extraction device 100 comprises a device frame 201, a soft tube capture slot 202, a locking and sealing arm 203, and a cutting handle 204. The soft tube 102 of beauty product may be inserted into the soft tube capture slot 202 underneath the locking and sealing arm 203 once the user has pushed the contents of the soft tube 102 to one end. The soft tube 102 of beauty product may be positioned with a dividing line across the soft tube between the empty portion of the tube 103 and a beginning portion of the beauty product underneath the locking and sealing arm 203. The user may still access the beauty product be removing the cap 104 to the soft tube 102 while the soft tube remains locked within the extraction device 101.

The extraction device 100 may also include a keyring hole 205 within the device frame 201 in order for a retention ring (not shown) or similar device to attach the extraction device 100 and any enclosed beauty product 102 to items within the user's bag for security and ease of location in the bag.

FIG. 3 illustrates an example embodiment of an article of manufacture for an all-in-one beauty product extraction device according to the present invention. The extraction device 100 is shown with the locking and sealing arm 203 positioned in a retracted, or open, position. The soft tube 102 easily fits within the soft tube capture slot 202 when the locking and sealing arm 203 remains in the open position. A safely-contained cutting blade 301 is coupled to an underside of the cutting handle 204. The cutting handle 204 wraps around the locking and sealing arm 203 such that the cutting handle 204 may slide up and down the length of the locking and sealing arm 203.

The extraction device 100 may then cut the soft tube 102 with the safely contained blade 301 as the cutting handle 204 slides along the locking and sealing arm 203 after the locking and sealing arm 203 has been placed into a closed position. The locking and sealing arm 203 has a first end coupled to the device frame 201 using a hinge. The second end of the locking and sealing arm 203 pivots upward and downwards to permit the soft tube of beauty product. The closed position is achieved when the free end of the locking and sealing arm 203 engages an arm retention clip or clasp located at the open end of the soft tube capture slot 202.

Movement of the cutting handle 204 along the locking and sealing arm 203 when the arm 204 is in the closed position causes the cutting handle 204 to drag the cutting blade 301 along the soft tube 102 horizontally. Leaving the locking and sealing arm 203 in the closed position seals the soft tube closed by pinching the opened end shut 102 between an edge of the soft tube capture slot 202 and the locking and sealing arm 203. Keeping the locking and sealing arm 203 in the closed position will preserve the lifetime of the product inside the soft tube 102. One embodiment of the extraction device 100 is a travel-sized device that easily will fit into a carry-on cosmetic bag and go through airport security because of the safely designed, enclosed, non-dangerous cutting application. The safely contained blade 301 is to be enclosed inside of the extraction device 100 so that it is unable to be removed/replaced.

Even though particular combinations of features are recited in the present application, these combinations are not intended to limit the disclosure of the invention. In fact, many of these features may be combined in ways not specifically recited in this application. In other words, any of the features mentioned in this application may be included in this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed:

1. An article of manufacture for an all-in-one beauty product extraction device, the article comprises:
a device frame;
a soft tube capture slot through the device frame having a first and second ends;
a locking and sealing arm coupled to a first end of the soft tube capture slot using a hinge; and
a cutting handle coupled around the locking and sealing arm permitting the cutting handle to slide along the locking and sealing arm from the first end to the second end;
wherein the cutting handle cuts through a soft tube located within the soft tube capture slot when the cutting handle slides from the first end to the second end of the locking and sealing arm.

2. The article of manufacture according to claim 1, wherein the locking and sealing arm has an open, retracted position and a closed position;
the cutting handle cuts through the soft tube located within the soft tube capture slot when the locking and sealing arm is in the closed position.

3. The article of manufacture according to claim 2, wherein the locking and sealing arm pivots from the retracted position to the closed position to engage an arm retention clip located at an open end of the soft tube capture slot.

4. The article of manufacture according to claim 2, wherein the cutting handle comprises a sliding handle and a safely contained blade on an underside of the sliding handle away from a user.

5. The article of manufacture according to claim 3, wherein the locking and sealing arm seals the soft tube located within the soft tube capture slot closed once the soft tube has been cut when the locking and sealing arm engages the arm retention clip.
